(19) United States
(12) Patent Application Publication
(10) Pub. No.: US 2005/0265041 A1
(43) Pub. Date: Dec. 1, 2005

(54) Optical body and optical arrangement including same

(76) Inventor: Frank Wimbert, Aachen (DE)

Correspondence Address: The Bilicki Law Firm, P.C., 1285 North Main Street, Jamestown, NY, 14701, US

(21) Appl. No.: 11/139,453

(22) Filed: May 27, 2005

(30) Foreign Application Priority Data
May 29, 2004 (DE) 10 2004 026 530.5

(51) Int. Cl. F21V 5/00

(52) U.S. Cl. 362/545; 362/520

(57) ABSTRACT

The optical body of the invention receives light given off by a light source into a conical spatial region with a central axis extending in the Z-direction. The optical body is substantially V-shaped in a section plane defined by the Z-direction and a X-direction perpendicular thereto. The limbs of the V-shape which respectively have outside and inside wall regions are arranged symmetrically relative to the central axis and converge towards a base portion of the optical body. To achieve uniform light distribution the base portion has a recess of such a depth that a light source whose light cone has an apex angle of approximately 180° extends into the recess to such a degree that substantially all its light is coupled into the optical body. Parts of the entering edge regions of the light cone are deflected on to outside wall regions of the base portion, reflected there and then distributed outwardly away from the central axis by multiple reflections between mutually opposite sub-portions of the inside and outside wall regions of each of the limbs of the V-shape.

### CROSS-REFERENCE TO RELATED APPLICATION

This application claims the priority of German patent application No 10 2004 026 530.5 filed May 29, 2004.

### FIELD OF THE INVENTION

The invention concerns an optical body and an optical arrangement which includes a plurality of such optical bodies and which for example is suitable for lamps, more specifically but not necessarily motor vehicle lamps.

### SUMMARY

There is provided an optical body comprising a material which is translucent for the light emitted by a light source into a conical spatial region with a central axis (also referred to herein as ZS) extending in a Z-direction, wherein in a section plane defined by the Z-direction and a X-direction perpendicular thereto the optical body is of a substantially V-shaped configuration and arranged in such a way that the limbs of the V-shape which respectively have outside and inside wall regions are arranged symmetrically with respect to the central axis of the conical spatial region and converge towards a base portion of the optical body which joins them and which is arranged at the light source. Set into the base portion of the optical body is a recess having a peripheral wall concentric with respect to the central axis and of such a depth that a light source which emits its light into a conical spatial region with an apex angle of approximately 180° can extend into the recess to such an extent that substantially all its light is coupled into the optical body At least parts of the edge regions, which enter into the optical body (3) through the peripheral wall, of the light cone coming from the light source are firstly deflected on to outside wall regions of the base portion, are reflected by said outside wall regions and are then distributed outwardly away from the central axis by multiple reflections between mutually oppositely disposed sub-portions of the inside and outside wall regions of each of the limbs of the V-shape.

The device according to one embodiment of the instant application comprises an optical arrangement for an elongate narrow lamp, for example a high-set brake lamp for motor vehicles, which includes a plurality of optical bodies as set forth in the immediately preceding paragraph, which are arranged in mutually juxtaposed and mutually adjoining relationship in a row in such a way that their X-directions are mutually aligned.

The device according to one embodiment of the instant application also comprises an optical arrangement for a lamp such as a motor vehicle lamp, which includes a plurality of optical bodies in accordance with the present invention, which are arranged in mutually juxtaposed and mutually adjoining relationship in a plurality of rows in such a way that in each row their X-directions are mutually aligned.

The optical body of the device according to the instant application is in a position to co-operate with a light source, in particular a light emitting diode, which emits its light with a Lambert's distribution into an almost hemispherical spatial region, that is to say it emits therefore a light cone whose apex angle is approximately 180°. Radial distribution of that light can be effected inter alia also by virtue of the fact that the edge regions of that very wide light cone, which pass into the optical body through the peripheral wall of the recess, can be initially expanded even more in order then to impinge on outwardly disposed wall regions of the base portion of the optical body, at which they can be reflected in such a way that they expand further in the interior of the optical body in parallel relationship or with a slight degree of divergence relative to the central ray. In that way the inner wall portions of the optical body according to the invention can be subdivided into two kinds of sub-portions which are generally arranged alternately and of which the first are shaped and oriented, similarly to the case in the previously discussed optical body, in such a way that they can reflect radially outwardly the light which impinges on them and which is substantially parallel to the central ray, but between which are disposed, unlike the situation with the above-outlined known optical body, two sub-portions which can couple the light which impinges on them and which is also approximately parallel to the central ray out of the optical body without or with a precisely controllable change in direction. That change in direction can be achieved by the provision in those second sub-portions of lens structures which can deflect the light passing therethrough, in such a way that the darker zones produced by the adjacent reflecting sub-portions can be lightened up and the result can thus be a very uniform distribution of intensity.

The innermost coupling-out sub-portion which is directly in opposite relationship to the end face of the recess provided in the base portion has the lightest light components shining therethrough. In order to compensate for this the size of that sub-portion can thus be selected to be smaller than the further outwardly disposed coupling-out sub-portions which involve somewhat weaker light.

The alternate arrangement of reflecting and coupling-out sub-portions imparts to the optical body according to the device according to the instant application a stepped structure which leads to smaller differences in the thickness of material.

An increase in the number of reflections which occur in the interior of the optical body, between inside and outside wall regions, can make it possible to illuminate an even larger area, with a single light source. Coupling-out sub-portions are then repeatedly disposed between the reflecting sub-portions of the inside wall regions, as are required for that larger number of reflections, the coupling-out sub-portions thus being arranged distributed over the entire expansion area.

In one embodiment, the optical body according to the instant application is delimited on each of two mutually opposite sides by a respective flat surface, wherein those surfaces are arranged in mirror-image symmetry, and in mutually parallel relationship with each other, in relation to a central plane which extends through the central ray of the light beam passing through the optical body. Accordingly the optical body is no longer rotationally symmetrical with respect to the central beam and distributes the light coupled into same in a direction parallel to the above-mentioned central plane over a substantially greater length than in the direction perpendicular thereto.

Such optical bodies can be added to each other in a very simple manner and in particular can be produced in one piece, in such a way that their directions are aligned with each other and the resulting optical arrangement is capable of illuminating a narrow but very elongate light transmission surface with a comparatively small number of light emitting diodes with a very high level of uniformity, as is required for example in the case of high-set brake lamps for motor vehicles. That uniformity can be still further improved in accordance with the invention by arranging after the row of optical bodies a further optical distribution member which for example can be formed by a lamp cover in the form of an optically active component on its side which is towards the optical bodies and/or remote from the optical bodies.

In one embodiment, the cover, on its side towards the optical bodies, has a plurality of cylindrical lenses whose mutually parallel axes extend transversely with respect to the longitudinal direction of the lamp cover or the above-mentioned direction of the row of optical bodies, and on its outside forms a single continuous cylindrical lens whose axis is perpendicular to the cylindrical lenses on the inside. As a result the cover has a completely smooth outside so that it can serve as a light transmission cover of a vehicle lamp even in situations in which it is intended for external installation, when the light transmission cover is therefore not covered over and protected from fouling by further transparent covers.

For internal installation situations of use the cover can also be provided with cushion-type optical means which impart to the outside thereof a structure involving raised portions and recesses.

The further optical distribution member can comprise the same injection-moldable material as the optical bodies so that all those elements can be produced integrally connected to each other as a single component. To stabilise such a molding the pre-distributing optical means formed by the interconnected optical bodies, in one embodiment, are connected by way of continuous limbs to the cover disposed in front thereof or alternatively connecting limbs can be provided on the outer edge which are not in the visible region of the optical means.

The cover disposed in a front position can be of a larger dimension transversely with respect to the longitudinal direction, than the pre-distributing optical means. In that case the light of the coupling-out sub-portions of the pre-distributing optical means is expanded by means of lenses provided on those coupling-out sub-portions, in such a way that the front-disposed cover is also illuminated completely and uniformly transversely with respect to the longitudinal direction. If necessary, the optically active structures arranged on the cover can be used for correction of differing expansion.

### BRIEF DESCRIPTION OF THE DRAWINGS

FIG. 1 shows a section through an optical body according to the invention,

FIG. 2a shows an optical arrangement comprising a plurality of optical bodies as shown in FIG. 1, connected together in a row, with a further optical distribution means arranged thereafter,

FIG. 2b shows a view from below of the optical arrangement of FIG. 2a, and

FIG. 3 is a view similar to FIG. 2a of a further embodiment of an optical arrangement according to the invention.

### DESCRIPTION OF EMBODIMENTS OF THE INVENTION

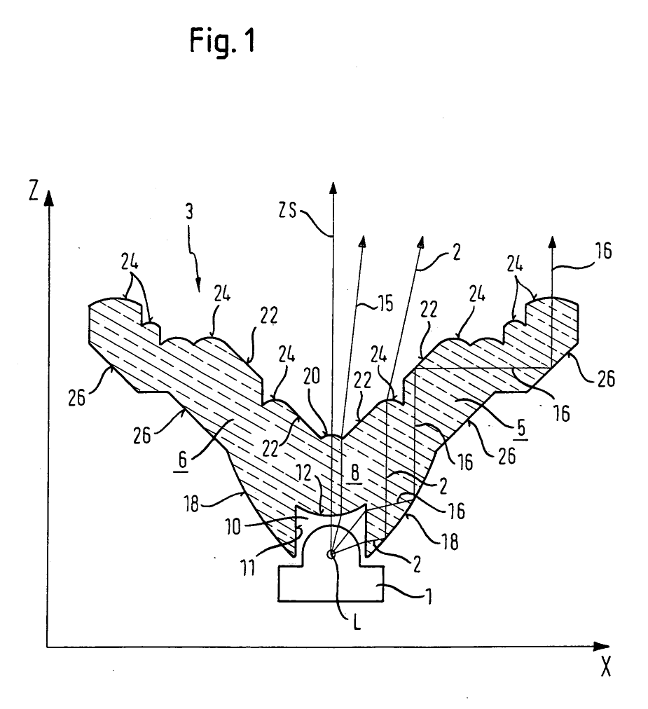

Referring to FIG. 1, shown therein is a light source 1 in the form of a light emitting diode which, as is indicated by the light ray 2 shown at the right in FIG. 1, emits its light with a substantially Lambert's distribution in a conical spatial region whose apex angle is approximately 180°.

The description hereinafter entails using a co-ordinate system X, Y and Z, wherein the Z-direction is to be defined by the central axis ZS of the light beam emitted by the light source 1. The planes of the drawing in FIGS. 1, 2a and 3 are respectively defined by the direction Z and a direction X perpendicular thereto. The Y-direction which is perpendicular to those X-Z planes therefore corresponds to the direction of view of the person viewing the drawing.

In order to use a maximum part of the light emitted by the light source 1 for illumination which is uniform as possible of a surface region which is transilluminated in the direction of the central axis ZS from the rear in approximately perpendicular relationship, that is to say which is in a plane parallel to the X-Y plane, arranged downstream of the light source 1 is an optical body 3 which is of a substantially V-shaped configuration in the section plane shown in FIG. 1, extending through the central axis ZS of the light source 1.

The two limbs 5, 6 of its V-shape are arranged symmetrically relative to the central axis ZS and converge towards a base portion 8 to which they are integrally connected and which is disposed in the immediate proximity of the light source 1.

In actual fact, provided in the side of the base portion 8, which faces towards the light source 1, is a sunk recess 10 which has a cylindrical peripheral wall 11 and whose end wall which is upward in FIG. 1 is curved in such a way that it forms a convergent lens 12.

The light source 1 projects with its housing into the recess 10 to such an extent that its light-emitting region L approximately coincides with the focal point of the convergent lens 12 which as a result serves as a collimator lens for the parts impinging thereon of the light emitted by the light source 1, so that the light rays in question in the interior of the optical body 3 firstly extend approximately parallel to the central axis ZS, as is indicated by the light ray 15.

In addition the light source 1 projects into the recess 10 to such an extent that practically all the light emitted thereby is coupled into the optical body 3, in which respect in particular the outer regions of the light cone which involves an apex angle of approximately 180° pass through the peripheral wall 11 of the recess 10 and in so doing are refracted somewhat towards the X-axis, as is illustrated in regard to the light rays 2 and 16.

The edge region, indicated by those two light rays 2, 16, of the light beam emitted by the light source 1 then impinges from the inside on an outside wall region 18 of the base portion 8, that outside wall region 18 being so shaped and oriented in space that it reflects the light beams impinging thereon, in approximately parallel relationship with the central axis ZS. The shape of the outside wall region 18 deviates from a parabola whose focal point coincides with the light-emitting region L of the light-emitting diode 1, for the reason that, when the light enters through the peripheral wall 11 of the recess 10, there is refraction towards the X-Y plane.

As indicated by the light ray 16, a part of the light reflected at the outside wall region 18 is transmitted in the interior of the optical body 3 in such a way that, when it issues from the optical body 3 after a plurality of reflections which occur in the interior thereof, it is at a substantially greater spacing from the central axis ZS than after the first reflection at the outside wall region 18. That is discussed in greater detail hereinafter.

On its side in opposite relationship to the convergent lens 12 the base portion 8 has a central exit region 20 which extends substantially perpendicularly to the central axis ZS. It can either be completely flat so that the light passing therethrough remains collimated in relation to the central axis ZS. Alternatively it is in the form of a lens which imparts a desired divergence to the light beam passing through the exit region 20. In that respect, not only is the FIG. 1 configuration in the form of a divergent lens possible, but also a configuration in the form of a convergent lens. In the latter case the light beam 15 would cross over the central axis ZS at a point defined by the focal length of that convergent lens, without a different divergence of the light beam passing through the exit region 20 having to occur in that case.

In the context of the present description, the wall regions of the limbs 5, 6 of the V-shape, adjoining the exit region 20, are referred to as ‘inside wall regions’because they are closer to the central axis ZS while the wall regions of the limbs 5, 6 of the V-shape, adjoining the outside wall region 18 of the base portion 8, are referred to as ‘outside wall regions’.

As can be seen from FIG. 1 the inside wall regions of the limbs 5, 6 of the V-shape are subdivided into first and second sub-portions 22 and 24 respectively, the first sub-portions 22 being so shaped and inclined relative to the Z-direction that they reflect the light which impinges thereon and which is propagated in the optical body 3 substantially parallel to the central axis ZS substantially perpendicularly to the ZS direction towards the outside wall regions of the limbs 5, 6 of the V-shape, as is illustrated for the light ray 16.

In comparison the second sub-portions 24 extend substantially in planes which are parallel to the X-Y plane, that is to say which are therefore perpendicular to the central axis ZS.

Those second sub-portions 24 can either be completely flat so that light which is propagated in the interior of the optical body 3 substantially parallel to the Z-axis passes through them without a change in direction, that is to say it retains its parallelism with respect to the central axis ZS.

Alternatively those two sub-portions 24 can also be in the form of light-refracting lenses, for example in the form of convergent or divergent cylindrical lenses or in the form of cushion-type optical members, in order to achieve further fine distribution of the light issuing from the optical body 3. The latter is illustrated in FIG. 1 which shows that, when it issues through the associated second sub-portion 24, the light ray 2 experiences a marked change in direction. Admittedly, the sub-portion 24 through which the light ray 16 issues is also in the form of a lens, but no change in direction is illustrated here, because it is assumed that the light ray 16 passes through that lens as a central ray.

As can further be seen from FIG. 1 the outside wall regions of the limbs 5, 6 of the V-shape have sub-portions 26 which are so shaped and inclined relative to the Z-direction that they reflect the light coming from the first sub-portions 22 of the inside wall regions and which is propagated substantially perpendicularly to the Z-direction, in such a way that thereafter it is further propagated in the interior of the optical body 3 substantially parallel to the central axis ZS.

That multiple reflection between the sub-portions 22 of the inside wall regions and sub-portions 26 of the outside wall regions of the limbs 5, 6 of the V-shape makes it possible to produce a light beam which is considerably expanded in relation to the light beam collimated after reflection at the outside wall regions 18 of the base portion 8 of the optical body 3, that is to say parallel to the Z-axis, but which still issues at least approximately collimated from the optical body 3.

It should be expressly pointed out that the inside and outside wall regions of the limbs 5, 6 of the V-shape can have more than the illustrated reflecting sub-portions 22, 26 so that for example, after its reflection at the outside wall portion 18 of the base portion 8, the light ray 16 is reflected not just twice but four times or more frequently, thereby permitting even greater spread of the light beam delivered by the optical body 3.

The sub-portions 22 of the inside wall regions of the limbs 5, 6 of the V-shape, which directly adjoin the exit region 20, are illustrated in FIG. 1 with the same angle of inclination as the sub-portions 22 serving for reflection of the light ray 16, and can also have a reflecting action. This means that virtually no light issues therethrough in the direction of the central axis ZS. The dark annular region which as a result potentially occurs and which surrounds the exit region 20 is lightened by the divergence, shown in FIG. 1, of the light beam issuing through the central exit region 20 (see the light ray 15).

The same also applies in regard to the further outwardly disposed reflecting sub-portions 22 which can also be lightened by virtue of the fact that the light issuing through the adjacent sub-portions 24 which extend substantially perpendicularly to the Z-direction is refracted by lenses provided there (converged or diverged) in such a way that it is divergent at least at a certain spacing from the respective sub-portion, as is indicated by the light ray 2.

In the embodiment described, total reflection occurs at the reflecting sub-portions 18, 22 and 26. In order to achieve a greater design configuration option in terms of the shaping of the optical body 3 and/or in regard to the choice of the refractive index of its material, it is however also possible for those surfaces to be vapor-deposited from the exterior with a mirror layer in order to achieve the desired reflection effects. Reflection can also occur at the sub-portions in question, at angles different from those described. In particular the angle of the change in direction at the sub-portions 22, 26 of the reflected light can be different from 90°. It will be noted that the sub-portions between which the light is reflected extend in mutually parallel relationship.

In principle the optical body 3 can be of a rotationally symmetrical configuration around the central axis ZS so that, in all section planes extending through the central axis ZS, it is of the same shape as is illustrated for example in FIG. 1.

If however the light emitted by the optical body 3 is to be expanded primarily in one direction, for example the X-direction, an optical body 3 which in the central Z-X plane is of the cross-section shown in FIG. 1 can be delimited by flat surfaces which are disposed in planes arranged in mirror-image symmetry with respect to the plane of the drawing in FIG. 1. In that case, expansion of the light beam takes place primarily in the X-direction and occurs only to a very limited degree in the Y-direction which is perpendicular thereto. The two flat boundary surfaces extend in mutually parallel relationship but can also converge towards each other. In the embodiment shown, the mutual spacing is so great that they do not intersect the recess 10 provided in the base portion 8 of the optical body 3.

Such optical bodies which are delimited by flat side surfaces are particularly suitable for illuminating rectangular surface regions which are in a plane parallel to the X-Y plane and which are of a markedly longer longitudinal dimension in the X-direction than in the Y-direction.

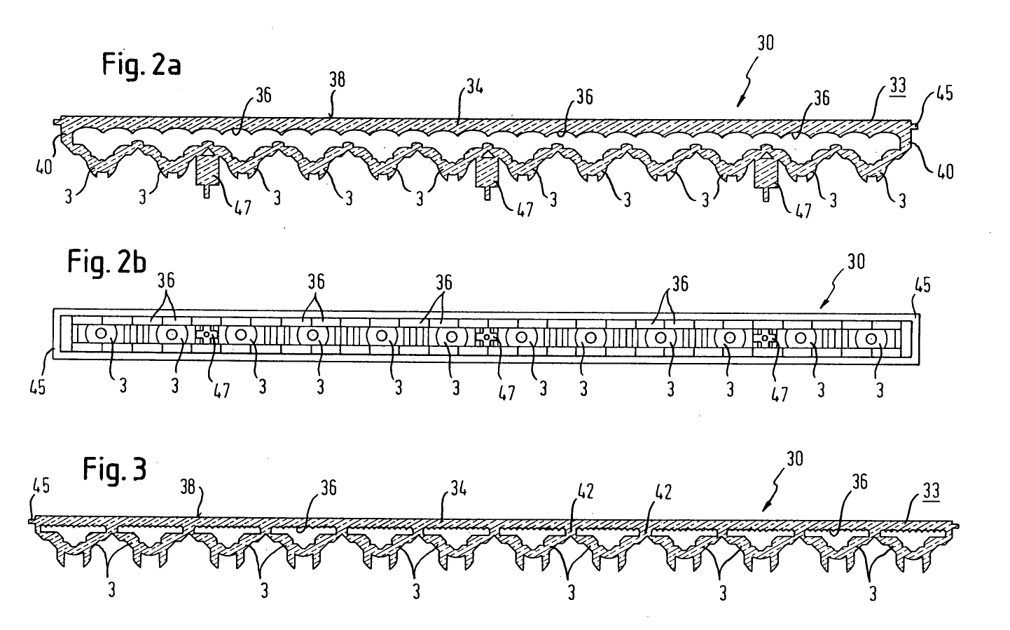

Particularly for illuminating light exit covers which are very elongated in the horizontal direction in the installation position, but which are of only a small height in the vertical direction, as are to be found in particular in relation to high-set motor vehicle brake lamps, then, as shown in FIGS. 2a, 2b and 3, a plurality of optical bodies 3 are arranged in mutually adjoining relationship in a row in such a way that their X-directions are aligned with each other and the optical arrangement 30 formed in that way extends in the longitudinal direction of the lamp in question.

As can be seen in particular from FIGS. 2a and 3, such an optical arrangement 30 includes a further optical distribution member 33 which, in the main direction Z of light propagation, is arranged downstream of the integrally interconnected optical bodies 3, but, as seen from the point of view of the person viewing the lamp in question, is disposed in front of same. That further optical distribution member 33 is in the form of a cover 34 which is made from the same material as the optical bodies 3 and which at the same time can also serve as a light transmission cover which closes the light exit opening of a lamp. In that embodiment, cylindrical lenses 36 serve to further distribute light in the X-direction and whose cylinder axes extend in the Y-direction, that is to say perpendicularly to the plane of the drawing in FIGS. 2a and 3, to be provided at the inside of the cover 34 and for the outside surface 38 of the cover 34 to be in the form of a single cylindrical lens whose axis extends in the X-direction. That last-mentioned cylindrical lens then serves to control the distribution of light in the Y-direction. The fact that a cover 34 of such a configuration has an outside surface which is admittedly curved but smooth means that it is particularly suitable for situations of use in which a lamp is to be so installed that the cover 34 forms a part of the outside surface of the motor vehicle because it does not have any recesses which promote the deposit of dirt and make cleaning more difficult.

As can further be seen from FIGS. 2a and 2b, the X-dimensions of the cylindrical lenses 36 are selected such that the resulting periodicity of the cylindrical lenses 36 does not form an integral ratio to the periodicity of the also substantially regularly arranged optical bodies 3 in order to avoid moiré effects.

The optical arrangements 30 can be produced in this fashion if the integrally interconnected optical bodies are also integrally connected to the cover 34 so that the optical arrangement 30 can be produced in the form of a single injection molding.

That integral connection can be made by a peripherally extending edge leg 40 as shown in FIG. 2a or in an alternate embodiment, as illustrated in FIG. 3, by a plurality of legs 42 which are then respectively arranged in the connecting region of two mutually adjacent optical bodies 3 in such a way that they there form a junction to the cover 34 disposed in front of the optical bodies.

In both cases the cover 34 is surrounded by a weld edge 45 which serves for connection to the lamp housing.

In addition FIGS. 2a and 2b show peening domes 47 or retaining hooks provided on optical inactive surfaces, optionally with positioning domes, for fixing the printed circuit board (not shown) carrying the light emitting diodes in an exactly defined position.

In order to achieve short cooling times, it is also possible to envisage a structural shape in which the coupling-out surfaces formed by the second sub-portions 24 are in the form of cylindrical lenses with axes parallel to the longitudinal axis X of the lamp or however also in the form of cushion-type optical members, each of those second sub-portions 24 forming a cushion-type optical member. With that embodiment it is possible for the primary optical light distribution members formed by the optical bodies 3 to be kept very narrow in the Y-direction, which signifies smaller wall thicknesses and thus shorter cycle times and a lower level of material expenditure when performing an injection molding operation. The expanded light then impinges on the cover 34 and shines through it in the entire Y-direction. The cylindrical external optical member 38 which is disposed in the longitudinal direction can reduce or increase vertical expansion of the light, according to the requirements involved in terms of light technology.

Particularly in the case of vehicle lamps which are intended for internal installation so that the light transmission cover thereof is not exposed to any particular risk of soiling, the cover 34 can also have a plurality of cylindrical and/or cushion-type optical members, on its side remote from the optical bodies 3.

Besides the above-described elongate brake lamps for motor vehicles, which are of a small height, the optical bodies according to the invention can also be used to produce a large number of different lamp configurations. By way of example optical bodies which in the above-described manner have two flat side surfaces can be used to form a plurality of rows in such a way that the X-directions of the optical bodies are mutually aligned in each row. Those rows can then be arranged in directly mutually adjoining relationship or at mutual spacings (transversely with respect to their X-direction). In the latter case it is possible to provide in the intermediate spaces between the rows individual ones or a plurality of further optical bodies whose X-direction extends transversely with respect to that of the rows. The rows which are arranged at spacings relative to each other also do not necessarily have to extend in mutually parallel relationship.

Particularly varied design configuration options are afforded if different lamp functions are attributed to light sources belonging to different optical bodies. In that respect, depending on the respective situation of use, a lamp function can be performed by just one light source with associated optical body or by a whole group of light sources and optical bodies.

It will be appreciated that the above-described embodiments of the invention have been set forth solely by way of example and illustration of the principles thereof and that further alterations and modifications may be made therein without thereby departing from the spirit and scope of the invention.

1. An optical body adapted to co-operate in use with a light source operable to emit light into a conical spatial region with a central axis extending in a Z-direction, wherein the optical body comprises a material which is translucent for the light emitted by the light source and in a section plane defined by the Z-direction and a X-direction perpendicular thereto the optical body is of a substantially V-shaped configuration having a base portion and first and second limbs which are joined to the base portion and respectively have outside and inside wall regions and the optical body is arranged in such a way that the limbs of the V-shape are arranged symmetrically with respect to the central axis of the conical spatial region and converge towards the base portion of the optical body, the light source in use of the optical body being arranged at the base portion,
the base portion comprising a recess having a peripheral wall concentric with respect to the central axis and of such a depth that said light source emitting its light into said conical spatial region with an apex angle of approximately 180° is receivable in the recess to such an extent that substantially all its light is coupled into the optical body, and
at least parts of edge regions of the light cone from the light source, which edge regions enter into the optical body through said peripheral wall are firstly deflected on to said outside wall regions of the base portion, are reflected by said outside wall regions and are then distributed outwardly away from the central axis by multiple reflections between mutually oppositely disposed sub-portions of the inside and outside wall regions of each of the limbs of the V-shape.

2. An optical body as set forth in claim 1
wherein the outside wall regions of the base portion are so shaped that they reflect the light impinging thereon for said light to be further propagated in the optical body substantially parallel to the central axis.

3. An optical body as set forth in claim 1
wherein the recess in the base portion comprises an end wall in the form of a convergent lens adapted to focus the parts impinging thereon of the light cone emanating from the light source in such a way that they are further propagated in the optical body substantially parallel to the central axis.

4. An optical body as set forth in claim 2
wherein the base portion of the optical body on its side in opposite relationship to the recess has a flat exit region which extends substantially perpendicularly to the central axis,
the arrangement being such that the parts impinging thereon of the light beam propagated in the optical body substantially parallel to the central axis issue therethrough substantially rectilinearly and parallel to the central axis.

5. An optical body as set forth in claim 2
wherein the base portion of the optical body on its side in opposite relationship to the recess has an exit region which extends substantially perpendicularly to the central axis and which is in the form of a lens,
the arrangement being such that the parts impinging thereon of the light beam propagated in the optical body substantially parallel to the central axis issue divergently.

6. An optical body as set forth in claim 4
wherein the inside wall regions of the limbs which adjoin the exit region have at least one first sub-portion and at least one second sub-portion of which the first is so shaped and inclined relative to the Z-direction that it is operable to reflect parts impinging thereon of the light beam which is propagated in the optical body substantially parallel to the central axis substantially perpendicularly to the Z-direction towards the outside wall regions of the limbs while the second sub-portion extends substantially perpendicularly to the central axis.

7. An optical body as set forth in claim 5
wherein the inside wall regions of the limbs which adjoin the exit region have at least one first sub-portion and at least one second sub-portion of which the first is so shaped and inclined relative to the Z-direction that it is operable to reflect parts impinging thereon of the light beam which is propagated in the optical body substantially parallel to the central axis substantially perpendicularly to the Z-direction towards the outside wall regions of the limbs while the second sub-portion extends substantially perpendicularly to the central axis.

8. An optical body as set forth in claim 7
wherein at least one of the second sub-portions is flat,
the arrangement being such that the parts impinging thereon of the light beam propagated in the optical body substantially parallel to the central axis issue substantially rectilinearly and parallel to the central axis .

9. An optical body as set forth in claim 7
wherein at least one of the second sub-portions is in the form of a lens,
the arrangement being such that that the parts impinging thereon of the light beam propagated in the optical body substantially parallel to the central axis issue divergently.

10. An optical body as set forth in claim 1
wherein the outside wall regions of the limbs include at least one sub-portion so shaped and inclined relative to the Z-direction that it is operable to reflect light coming from the first sub-portions of the inside wall regions and propagated substantially perpendicularly to the Z-direction whereby it is further propagated after reflection in the interior of the optical body substantially parallel to the Z-direction.

11. An optical body as set forth in claim 1
wherein the outside wall regions of the base portion are reflecting and are so shaped and oriented for total reflection to occur for light impinging thereon from the inside.

12. An optical body as set forth in claim 1
wherein the sub-portions of the inside and outside wall regions of the limbs are reflecting and are so shaped and oriented for total reflection to occur for light impinging thereon from the inside.

13. An optical body as set forth in claim 1
which is of a rotationally symmetrical configuration with respect to the central axis.

14. An optical body as set forth in claim 1
which is delimited by first and second flat surfaces which are disposed in first and second planes arranged in mirror-image symmetrical relationship with respect to the Z-X plane,
the arrangement being such that the optical body is of a substantially greater extent in the X-direction than in the Y-direction perpendicular to the Z-direction and to the X-direction.

15. An optical body as set forth in claim 14
wherein the planes arranged in mirror-image symmetry with respect to the Z-X plane extend in mutually parallel relationship.

16. An optical body as set forth in claim 14
wherein the spacing of the planes arranged in mirror-image symmetry with respect to the Z-X plane is slightly larger in the region of the recess in the base portion than the diameter of the recess.

17. An optical arrangement for an elongate narrow lamp comprising
a plurality of optical bodies as set forth in claim 1
which are arranged in mutually juxtaposed and mutually adjoining relationship in a row with their X-directions mutually aligned.

18. An optical arrangement for a lamp comprising
a plurality of optical bodies as set forth in claim 1
which are arranged in mutually juxtaposed and mutually adjoining relationship in a plurality of rows with their X-directions in each row mutually aligned.

19. An optical arrangement as set forth in claim 18
wherein at least two of the plurality of rows are arranged in mutually parallel relationship.

20. An optical arrangement as set forth in claim 18
wherein at least two of the plurality of rows are arranged at a spacing from each other in a direction extending transversely relative to the X-direction of the optical bodies.

21. An optical arrangement as set forth in claim 20 including
further optical bodies arranged at least between two of the plurality of spaced rows.

22. An optical arrangement as set forth in claim 21
wherein the X-directions of the further optical bodies extend in non-parallel relationship to the X-directions of the optical bodies in the rows.

23. An optical arrangement as set forth in claim 17
wherein at least some of the optical bodies are integrally connected together.

24. An optical arrangement as set forth in claim 17 including
a further optical distribution means arranged downstream of the optical bodies to provide for further re-distribution of light issuing from the optical bodies.

25. An optical arrangement as set forth in claim 24
wherein the further optical distribution means is formed by a translucent cover which on its side towards the optical bodies has a plurality of cylindrical lenses having axes extending in mutually parallel relationship and perpendicularly to the X-direction of the optical bodies (3).

26. An optical arrangement as set forth in claim 24
wherein the further optical distribution means is formed by a translucent cover which on its side remote from the optical bodies is in the form of a single continuous cylindrical lens whose axis is perpendicular to the axes of the cylindrical lenses provided on the side towards the optical bodies.

27. An optical arrangement as set forth in claim 24
wherein the further optical distribution means is formed by a translucent cover having a plurality of cushion-type optical means on one of its sides.

28. An optical arrangement as set forth in claim 24
wherein the further optical distribution means is integral with the optical bodies.
